(19) United States
(12) Patent Application Publication
(10) Pub. No.: US 2018/0122171 A1
(43) Pub. Date: May 3, 2018

(54) SMART CARD DUPLICATION DEVICE

(71) Applicant: LISA M. PEARSON, NORTH LAS VEGAS, NV (US)

(72) Inventor: LISA M. PEARSON, NORTH LAS VEGAS, NV (US)

(21) Appl. No.: 15/339,837

(22) Filed: Oct. 31, 2016

(51) Int. Cl. G07C 9/00; G06F 21/31

(52) U.S. Cl. CPC G07C 9/00904; G07C 2009/00436; G07C 9/00309; G06F 21/31

(57) ABSTRACT

This invention relates to a system for key dispensing from an electronic key kiosk and method thereof. Firstly, the method providing an electronic key device to a user for dispensing a duplicate key, a login credential to the user for authenticating into the electronic key device, associating the login credential of the user to a plurality of master keys, instructing the user for a duplicate key dispensing process using a plurality of peripheries and receiving the duplicate key from the electronic key device by the user under an observation of a video recording unit.

### BACKGROUND OF THE INVENTION

### (1) Field of the Invention

The present invention relates to the field of system and method for dispensing a copy of a master key or a new master key. The invention, particularly relates to a system for key dispensing to an authorized user and method thereof.

### (2) Background of the Invention

In recent years, although attempts have been made to provide automatic key duplicating machines which are suitable for unattended use by the public, usually by the insertion of a defective key, so far as is known none of such prior art actuated machines for making duplicate keys have been successful commercially.

In conventional, key duplicating machines having complicated mechanisms have not been suitable for complete automatic operation. Ideally, a user would only need to insert a master key in one slot, enter valid information, and receive a duplicate key. However, most prior key duplicating machines are designed such that the keys move during the duplicating process. As a result, these machines are not easily provided with slots for the insertion of the keys.

There have been a number of solutions provided for duplicate key dispensing or dispensing with the similar types of functions and few of them have been discussed below, wherein all are herein incorporated by reference for their supportive teachings, but none in combination or by themselves teach the disclosed embodiments of this application, wherein:

US 20040046018 A1 relates to an electronic lock system which allows unattended dispensing of user determined key codes. These user determined key codes are then utilized by the user to gain access to secure lock system for providing user access to an area includes a terminal interfacing with a user and receiving a user determined key code from the user. An access locking device blocks access to the area, but after the user inputs the user determined key code to the access locking device the access device unlocks and provides access to the area.

US 20090074528 A1 discloses a method for duplicating a key including receiving a key identification code indicative of key cuts in an original key, and duplicating the original key by forming key cuts in a duplicate key in response to the key identification code, wherein authorization to form the key cuts is restricted by means of a verification code that must be passed before forming the key cuts is permissible.

US 20070003388 A1 describes a method to make a copy of a key from stored data has acts of inputting identifier data, comparing the input identifier data with stored identifier data, responding to the identifier data, transmitting the key data to a key cutting machine and making a copy of the key.

EP 2709045 A1 relates to a system for allowing a guest to make a lodging reservation for staying during a selected period in a lodging facility, and for automatically assigning a room and providing a key to the assigned room, and for automatically providing personalized inform.

U.S. Pat. No. 5,204,663 teaches an access control system for controlling access including an integrated ciruit key card with sufficient memory to store key access information.

U.S. Pat. No. 6,975,202 teaches an electronic key to open electronic locking devices where the key code is sent to a user's wireless communication device that is later used to open a corresponding locking device.

U.S. Pat. No. 6,989,732 teaches an improved electronic lock system for use with reaestate lock boxes and each user has an identification cared with a non-volatile security memory (smart card).

U.S. Pat. No. 7,009,489 teaches of an improved electronic lock that is for use with real estate lock boxes where there are many people to access a single property.

U.S. Pat. No. 7,051,561 teaches a mortise lockset apparatus that includes a key card reader module that enables the lockset apparatus to operate when an appropriate smart card is placed into the key card reader module.

These prior art systems and method, which have been herein incorporated by reference, for making a copy of a key suffer from a number of disadvantages. They are not providing a complete solution to a user while they are not having any defective or old key and further, the systems are also not providing any verification of the user. Although not a very complex system, this design is not the most accurate for making a plurality of keys since the system is prone to the mechanism of wobbling as it moves up and down in response to the edge variations in the master key. Also, the process is fraught with potential problems and mistakes. The solution of this application addresses a system and method in which the user is making a copy of a master key using their login credential and also a video recorded premise to monitor the activities of the user.

The present disclosed embodiments provide a system for key dispensing from an electronic key kiosk and method thereof, which overcomes these disadvantages and provides additional advantages over the prior art by providing a simple functionalities to make a copy of the master key with a suitable means of authentication for a user.

### SUMMARY OF THE INVENTION

In the view of the foregoing disadvantages inherent in the known types of automated key dispensing system and method thereof, now present in the prior art, the present invention provides an improved system and method for key dispensing from an electronic key kiosk. As such, the general purpose of the present invention, which will be described subsequently in greater detail, is to provide a new and improved system for key dispensing from an electronic key kiosk and method thereof, which has all the advantages of the prior art and none of the disadvantages.

An object of the invention is to provide a method for key dispensing, which includes the steps of providing an electronic key device to a user for dispensing a duplicate key, providing a login credential to the user for authenticating into the electronic key device, associating the login credential of the user to a plurality of master keys, instructing the user for a duplicate key dispensing process using a plurality of peripheries and receiving the duplicate key from the electronic key device by the user under an observation of a video recording unit.

It is another object of the present invention to provide an electronic key kiosk or device having a touchscreen device or a keypad for dispensing a duplicate key of a room or a place to the user whose key has got de-magnetized, lost or stolen and further, the electronic key kiosk that is linked to the system of a front desk of an administrator.

It is another object of the present invention to provide a kiosk that assigns a duplicate key to a user only when, the user name and password input by the user match with the information on the system of the administrator.

It is another object of the present invention to provide a key dispensing system that includes an electronic key device or kiosk for processing a user input, a means for authenticating the user input into the electronic key device, a means for dispensing a duplicate key resided in the electronic key device and a means for input to insert the user input in the electronic key device.

It is another object of the present invention to provide the kiosk that assigns duplicate key/s to the user according to information on a front desk system.

It is another object of the present invention to provide the kiosk that can be safely operated by the user and having an accelerated process. Such a Kiosk saves time of the premise manager, security officials and the like. In addition, helps the user to avoid long queues.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an isometric view of one embodiment of an electronic key kiosk or device in accordance with an embodiment of the present invention.

FIG. 2 is a swim lane flow chart of the operation of one embodiment of the disclosed invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides a key dispensing system that comprises: an electronic key device or kiosk, a means for authenticating the user input, a means for dispensing a duplicate key and a means for input to insert the user input. Further, the system is using a method that provides an electronic key device (3) to a user for dispensing a duplicate key by assigning a login credential to the user for authenticating into the electronic key device, associating the login credential of the user to a plurality of master keys, instructing the user for a duplicate key dispensing process using a plurality of peripheries and receiving the duplicate key from the electronic key device by the user under an observation of a video recording unit.

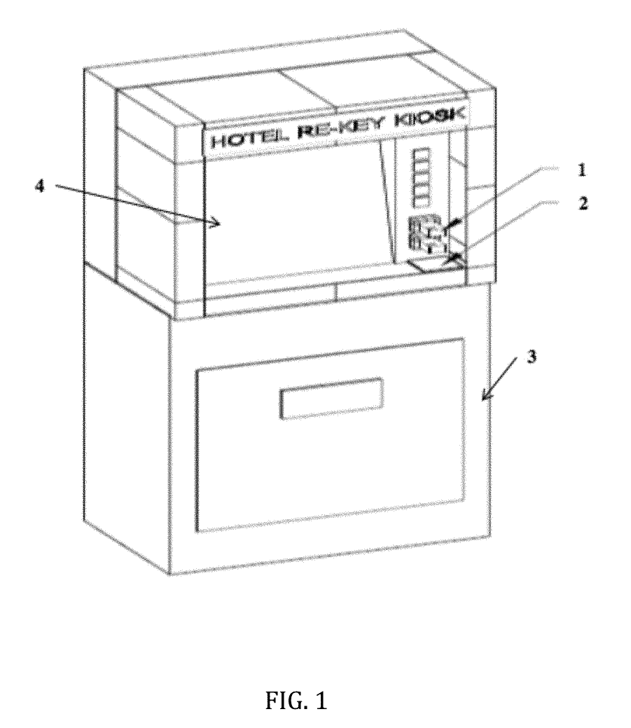

As shown in FIG. 1, an electronic key kiosk or device (3) for dispensing the duplicate key to the user while the user's key has got de-magnetized, lost or stolen. The system and method enables a user to generate a duplicate of the key without the presence of the original key. This can be accomplished by retrieving the stored information from a hosting server using a login credential which is installed at the front desk of the premissis or at the administrative end, and dispensing the key to the user. The system is having a means for authenticating the user by detecting the user input into the electronic key device via a means for input.

In accordance with an embodiment of the present invention, the electronic key device or kiosk can include a display (4), a processor in data communication with a computer network and an input interface between a user and the processor. The system and method verifies a user identification through their login credential by using the means for authenticating, i.e. a logic server, which connected to a host server of the front desk or at the administrative end by a user interface. Preferably, the user interface is, but not limited to, enabling the user to select the number of the duplicate key on the display unit of the electronic key device and in addition, the user interface also helps to select a mode of operation for the user by providing either a new key to a new user or an old or defective key replacement with a new key for the existing user. The login credential of the user is entered by a means for input, i.e. a keypad (2) or a touchscreen device which has been overlaid at the electronic key device.

The electronic key device or kiosk is configured to dispense the duplicate key using a means for dispensing. Preferably, the means for dispensing is, but not limited to, a slider box (1) to receive the duplicate key and an insertion unit for inserting an old key or a defective key. Further, the electronic key device or kiosk is installed, but not limited to, in a video recording for monitoring the activities of the user.

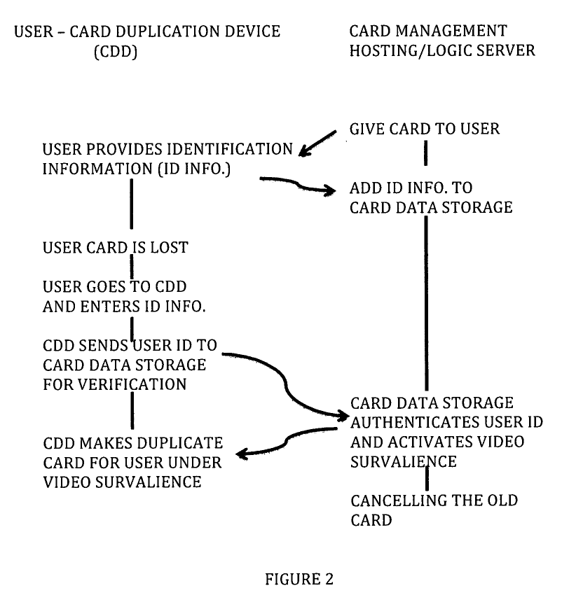

Referring now to FIG. 2, there is illustrated one embodiment of a flow of steps in the operation of thereof. Specifically, there are two swim lanes of information, one for the user and card duplication device, and the second is the card management, which are connected through a computer network. To begin the operation, the card management gives a card to a user, and the user provides identification information (ID INFO.) to the card management who then adds the ID INFO to a card data storage, also referred to as a master key information system, which is stored on a hosting server or logic server. Thereupon, when a situation occurs to the card that makes it unusable, like it being lost, the user then goes to the card duplication device (CDD) and enters the ID info., whereby the CDD sends the user ID info. to the card data storage that authenticates the user ID info. Now, the CDD can make a duplicate card for the user. In the situation where the old card is damaged, or demagnetized, the use is instructed to insert the defective key or an old key into the CDD before a new one can be dispensed or created.

The abovementioned electronic key device or kiosk provides a hassle free process to dispense a duplicate key to the authorized persons using their login credential while the user does not have a key by any of the following common reasons: either stolen, de-magnetized or misplaced. The user can also exchange the old or defective key using their login credential. The present invention also provides a device for assigning a duplicate key to the user without approaching the front desk, premissis manager, customer care executive or security official by matching the information of the user in the kiosk, with the information present on the system with the front desk or administrator. The user can be easily use the kiosk and also, the kiosk can be installed at any required place for the sake of ease. In addition, the present invention covers all security risk as a person other than the user cannot dispense the duplicate key to gain access to the locked unauthorized places and furthermore, the activities of the user are recorded by a video recording device. Finally, the old card is cancelled to prevent a stolen card, or other situations, from being used by another unauthorized user.

One skilled in the art of smart card operation will easily understand there are many variation to the presently disclosed embodiment wordings. For example, despite the usage of the word KEY throughout the disclosure, it is evident that this is also referring to a smart card, or just card. Additionally, the use of the wording kiosk is also refereed to as a device, and is representing the whole card duplication device, where the use can have a duplicate card, smart card or key be made for them.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A method for creating a duplicate electronic key for a user, comprising:
a) providing an electronic key duplication device to a user for dispensing a duplicate electronic key;
b) creating a login credential for the user, for authentication purposes, and for entry into the electronic key duplication device to create the duplicate electronic key;
c) storing the login credential in a master key information system that is stored on a hosting server;
d) matching the login credential of the user to the login credential information stored in the master key information located on a hosting server, when the login credential of the user is entered into the electronic key duplicate device;
e) allowing the electronic key duplication device to create a duplicate electronic key for the user when the login credential matches the login credential stored in the master key information located on the hosting server; and
f) providing the user the duplicate key from the electronic key duplication device under an observation of a video recording unit.

2. The method for key dispensing according to claim 1, wherein the login credential is authenticated by a logic server.

3. The method for key dispensing according to claim 2, wherein the logic server is communicatively coupled to the hosting server by a computer network.

4. The method for key dispensing according to claim 1, wherein the hosting server stores a plurality of user login credential details in a database.

5. The method for key dispensing according to claim 1, wherein the step of instructing the user for the duplicate key dispensing process comprising the step of canceling an old key in replacement of a new key for allotting of a new space to the user.

6. The method for key dispensing according to claim 5, wherein the step of canceling includes verification of the new key using detail of an old space and the old key.

7. The method for key dispensing according to claim 1, wherein the step of instructing the user for the duplicate key dispensing process includes insertion of a defective key or an old key.

8. The method for key dispensing according to claim 1, wherein the step of instructing the user for the duplicate key dispensing process further includes selecting a numbers of the duplicate key to be taken out from the electronic key device.

9. A key dispensing system, comprising:
an electronic key device for processing a user input;
a device for authenticating the user input into the electronic key device using a host server;
a device for dispensing a duplicate key resided in the electronic key device; and
a device for input to insert the user input in the electronic key device.

10. The system according to claim 10, wherein the electronic key device comprises a display unit a processor and electronic key duplication making unit.

11. The system according to claim 10, wherein the user input is selected from a plurality of defective keys and an old key.

12. The system according to claim 10, wherein the device for authenticating includes a logic server.

13. The system according to claim 12, wherein the logic server is configured to verify a user profile data associated with a login credential.

14. The system according to claim 13, wherein the login credential details is stored in a database of the host server.

15. The system according to claim 12, wherein the logic server is connected to the host server by a computer network.

16. The system according to claim 10, wherein the means for input is a keypad for the electronic key device.

17. A method of replacing an unusable smart card hotel room key for a user for a hotel room door lock, comprising the steps of:
a) a smart card hotel key management gives the smart card hotel key to the user;
b) the user provides user identification information to the smart card hotel key management;
c) the smart card hotel key management adds the user identification information to a smart card hotel key data storage, which is stored on a hosting server;
d) upon a user experiencing an unusable smart card hotel key, the user accesses a smart card hotel key duplication device and enters the user identification information;
e) the smart card hotel key duplication device sends the user identification information to the smart card hotel key data storage that authenticates the user identification information; and
f) upon proper verification that the user entered matching user identification information, the smart card hotel key duplication device will make a duplicate smart card hotel key for the user.

18. The method of claim 17, wherein, in a situation where a smart card hotel key is damaged, or demagnetized, the use is instructed to insert the damaged smart card hotel key into the smart card hotel key duplication device before a new one can be dispensed.

19. The method of claim 18, wherein upon the user accessing the smart card hotel key duplication device, a video surveillance system is activated to capture video of the user that is accessing the smart card hotel key duplication device.
